(19) United States
(12) Patent Application Publication
(10) Pub. No.: US 2006/0245725 A1
(43) Pub. Date: Nov. 2, 2006

(54) Apparatus and method for providing content list of portable device

(75) Inventor: Jin-ho Lim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/410,055

(22) Filed: Apr. 25, 2006

(30) Foreign Application Priority Data
Apr. 28, 2005 (KR) 2005-35546

(51) Int. Cl. H04N 7/00

(52) U.S. Cl. 386/95

(57) ABSTRACT

Apparatus for providing a content list of a portable device includes: a port sensing unit sensing a connected port by detecting a connection state between a portable device and an external device; a controller providing a list of content reproducible in the external device to the portable device based on the kind of sensed port; a menu generator generating a content list menu, which a user can perceive, using the provided content list; and a display unit displaying the generated content list menu. Accordingly, a list of content stored in a portable device, which can be reproduced in an external device connected to the portable device, can be automatically constructed and provided to a user.

### CROSS-REFERENCE TO RELATED PATENT APPLICATION

This application claims the benefit of Korean Patent Application No. 2005-35546, filed on Apr. 28, 2005 in the Korean Intellectual Property Office, the disclosure of which is incorporated herein in its entirety by reference.

### BACKGROUND OF THE INVENTION

1. Field of the Invention

Aspects of the present invention relate to a method and apparatus for providing a content list menu of a portable device, and more particularly, to a method and apparatus for automatically generating a menu for satisfying user requirements according to a physical port selected in a portable device that can reproduce audio/video (AV) content and automatically providing a content list menu allowing the user to easily access the content.

2. Description of the Related Art

A general portable device has physical ports, (e.g. a TV output port, a digital serial bus IEEE 1394 port, and a USB port), to interface for various purposes. Each interface reflects a different purpose of a user, and is determined according to user requirements. For example, a connection of a TV to a portable device is needed to watch video content stored in the portable device through a bigger display. A connection of an audio receiver to the portable device is needed to reproduce music files stored in the portable device through the audio receiver. That is, unlike passive devices for which connection between devices is fixed, since the user connects an external device to a portable device only when the user has a predetermined purpose, it is clear that the user has a specific purpose when the user connects the external device to the portable device.

FIG. 1 is a flowchart illustrating a process of providing a content list to a user when an external device having a physical interface with a portable device according to the prior art is connected to the portable device. In the prior art, when a cable is inserted into a portable device port to connect an external device to a portable device, a mode or menu of the portable device is not changed. That is, when a user inserts the cable into the portable device (for example, a TV analog cable is inserted into an output port of the portable device to connect a TV to the portable device) in operation S110, the user checks a menu displayed on the portable device in operation S120.

In operation S130, the user determines whether the displayed menu is desired by the user. If the menu desired by the user is displayed, in operation S150, the user reproduces and watches still images or video content selected by the user. If the menu desired by the user is not displayed, in operation S140, the user performs a procedure of moving a directory path of AV content stored in a storage unit of the portable device to a menu of an upper layer or a menu of a lower layer and confirming whether the menu desired by the user is displayed. The user can reproduce content after repeating the procedure until the menu of a content list desired by the user is displayed.

Even if a demand of the user is made clear by connecting an external device to the portable device, a mode of the portable device according to the external device must be changed every time, and if a menu for reproducing desired content is not displayed, the user must search for the desired menu every time.

### SUMMARY OF THE INVENTION

Aspects of the present invention provide a method and apparatus for providing an optimal user interface to a user by sensing whether a cable for connecting an external device is inserted into a port of a portable device, and the kind of cable.

Aspects of the present invention also provide a method and apparatus for automatically constructing a list of content stored in a portable device, which can be reproduced in an external device connected to the portable device, and providing the content list to a user.

According to an aspect of the present invention, an audio/video (AV) file reproducing apparatus comprises: a port sensing unit sensing a connected port by detecting a connection state between a portable device and an external device; a controller providing a list of content reproducible in the external device to the portable device based on a kind of the sensed port; a menu generator generating a content list menu, which a user can perceive, using the provided content list; and a display unit displaying the generated content list menu.

According to an aspect of the invention, if content lists are pre-generated according to content type, the controller transmits the generated content lists to the menu generator.

According to an aspect of the invention, if the sensed port is an analog/digital audio port, the controller provides a content list by searching for audio content reproducible in an external device connected through the analog/digital audio port among content stored in the portable device.

According to an aspect of the invention, if the sensed port is an analog AV port, the controller provides a content list by searching for audio, photograph, and video content reproducible in an external device connected through the analog AV port among content stored in the portable device.

According to an aspect of the invention, if the sensed port is a port protocol selected between USB port, an IEEE 1394 port, and a High-Definition Multimedia Interface (HDMI) port, the controller provides a content list by searching for digital AV content among content stored in the portable device according to each protocol.

According to an aspect of the invention, the AV file reproducing apparatus further comprises: a storage unit storing the content list generated by the controller.

According to an aspect of the invention, the content list is obtained by configuring a list of content reproducible in the external device in a tree pattern according to the type of the content, and a content list according to the type of the content is allocated and stored for each port.

According to another aspect of the present invention, an audio/video (AV) content reproducing method comprises: sensing a kind of connected port by detecting a connection state between a portable device and an external device; providing a list of content reproducible in the external device to the portable device based on the kind of sensed port; generating a content list menu, which a user can perceive, using the provided content list; and displaying the generated content list menu.

According to another aspect of the present invention, a portable device, which reproduces audio/video (AV) content, comprises: a port sensing unit sensing a connected port by detecting a connection state between the portable device and an external device; a controller providing a list of content reproducible in the external device to the portable device based on the kind of sensed port; a menu generator generating a content list menu, which a user can perceive, using the provided content list; and a display unit displaying the generated content list menu.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart illustrating a process of providing a content list to a user when an external device having a physical interface with a portable device according to the prior art is connected to the portable device;

FIG. 2 is an illustration of portable devices physically interfacing with other devices in various ways according to an embodiment of the present invention;

FIG. 3 is a schematic block diagram of a portable device according to an embodiment of the present invention;

FIG. 4 is a diagram of a software layer configuration for generating a content list menu which can be realized in a portable device according to an embodiment of the present invention;

FIG. 5 is a flowchart illustrating an automatic menu construction algorithm according to an embodiment of the present invention;

FIG. 6 is a detailed flowchart illustrating the automatic menu construction algorithm of FIG. 5; and

FIG. 7 is a flowchart illustrating an automatic menu construction algorithm according to another embodiment of the present invention.

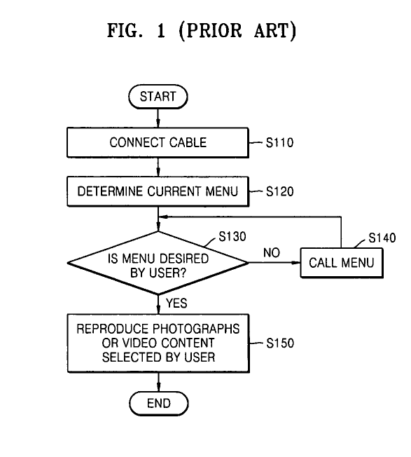

### DETAILED DESCRIPTION OF THE EMBODIMENTS

Reference will now be made in detail to the present embodiments of the present invention, which will now be described in detail with reference to the accompanying drawings, wherein like reference numerals refer to the like elements throughout. The embodiments are described below in order to explain the present invention by referring to the figures.

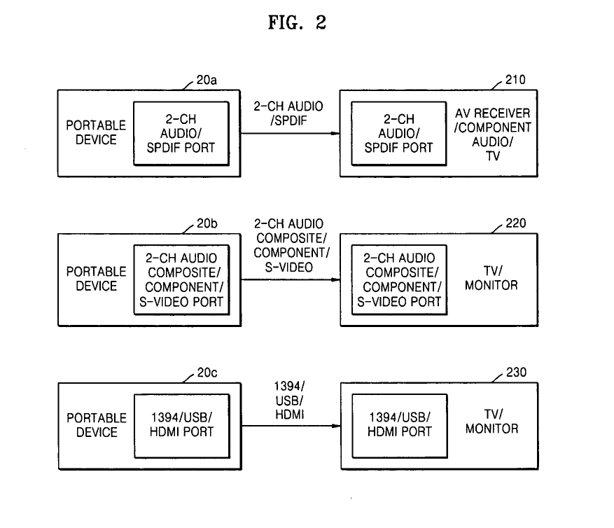

FIG. 2 is an illustration of portable devices 20a, 20b, 20c physically interfacing with other devices in various ways according to an embodiment of the present invention. Referring to FIG. 2, the portable device 20a has a 2-channel audio port and a Sony/Philips Digital Interface (SPDIF) port and is used by a user to listen to audio content stored in the portable device 20a using an external device 210, such as an AV receiver, a component audio, or a TV. In this case, the portable device 20a and the external device 210 are connected through a 2-channel audio cable or an SPDIF cable. While not required in all aspects, the portable device 20a decodes the stored audio content output through the 2-channel audio cable and/or an SPDIF cable.

The portable device 20b has an AV analog port and is used for a user to listen to or watch audio, photographs, or video content stored in the portable device 20b using an external device 220. The AV analog port includes a 2-channel audio port, a composite port, a component port, and an S-video port. In this case, the portable device 20b transmits a composite video signal, a component video signal, an S-video signal, or an audio signal to the external device 220 (i.e. an AV receiver such as a TV or a monitor). While not required in all aspects, the portable device 20b decodes the stored audio, photographs, or video content output through the 2-channel audio port, the composite port, a component port, and/or the S-video port.

The portable device 20c has an IEEE 1394 port/USB port/HDMI port and is used for a user to watch digital AV content stored in the portable device 20c using an external device 230 such as a TV or a monitor. When the external device 230 is connected to the IEEE 1394 port or the USB port of the portable device 20c, content such as an MPEG transport stream (TS) can be reproduced by the external device 230, and when the external device 230 is connected to the HDMI port of the portable device 20c, non-compressed digital AV content can be reproduced by the external device 230. While not required in all aspects, the portable device 20c decodes the stored digital AV content output through the IEEE 1394 port/USB port/HDMI port.

The portable devices 20a, 20b, and 20c can have different arrangements of ports according to an external device to be connected such that each device 20a, 20b, 20c can be connected using more or fewer protocols. Moreover, it is understood that the connection can be through wireless “ports” having corresponding protocols, such as WIFI, Bluetooth, etc. and other like ports.

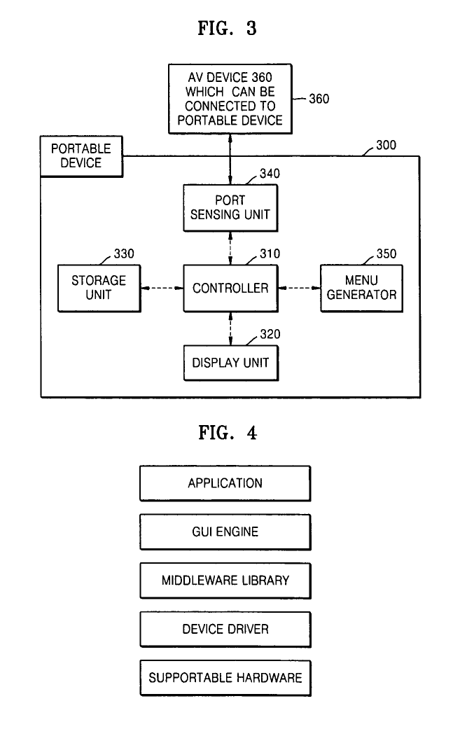

FIG. 3 is a schematic block diagram of a portable device 300 according to an embodiment of the present invention. Referring to FIG. 3, the portable device 300 includes a controller 310, a display unit 320, a storage unit 330, a port sensing unit 340, and a menu generator 350. The controller 310 controls the portable device 300 by including a video processor (not shown) receiving an image signal from the outside and generating an image signal having a proper format and a microprocessor (not shown) controlling the entire operation of the portable device 300. The signal processed by the video processor can be output through the display unit 320. Alternately, if the display unit 320 is not included in the device 300, the display unit 320 can be an external display to which the device 300 is connected.

The controller 310 recognizes a cable inserted into a port sensed by the port sensing unit 340 and determines the corresponding protocol. Based on the determined protocol, the controller 310 searches for content stored in the storage unit 330, and generates a list for each content type usable with the determined protocol according to the search. In addition and while not required in all aspects, if existing content lists usable with the determined protocol are pre-stored in the storage unit 330, the controller 310 extracts the corresponding existing content list and provides a content list menu to a user using the menu generator 350. If updated content is not included in a corresponding content list, the controller 310 can update and store the content list every time a port is connected or every time new content is downloaded, and then provide the updated content list to the user.

The menu generator 350 generates a content list menu having a graphic and/or text pattern using the generated content list so that the user can easily perceive the content list menu. As such and while not included in all aspects, the generated content list can include names of titles, track names, artist names, thumbnail pictures of the content, icons of the content type, etc., and can be further sortable according to this type of information. According to the current embodiment of the present invention, the menu generator 350 is separate to the controller 310 but can also be included in the controller 310.

Various types of AV files, which can be stored and reproduced in the portable device 300, are stored in the storage unit 330, and the storage unit 330 is configured to store content lists generated by the controller 310. Moreover, it is understood that other types of data can be stored, such as computer software or database information (such as used in personal electronic organizers) for use in connected computers or other portable electronic devices, as well as “.pdf” and other electronic document formats.

While not required in all aspects, the content lists can be configured as a tree pattern according to content type. The content lists according to content types can be stored as lists, which can be provided for each port type. For example, a list of audio content is allocated and stored in a directory of a lower layer of a list to be provided when an SPDIF port is connected, a list of photographs or video content is allocated and stored in a list to be provided when an analog AV port is connected, and a list of reproducible AV content of an MPEG TS format is allocated and stored in a list to be provided when a USB port or an IEEE 1394 port is connected. Using the stored lists, a content list according to a port can be provided when the port is sensed by the port sensing unit 340. These associations between protocol type and data type can be assigned by a user and/or can be otherwise determined (such as by a standard or a device 300 manufacturer). Additionally, it is understood that ones of the content types can be usable with plural external devices (such as a computer and a display) such that the branches of the tree can each include the common content.

The port sensing unit 340 includes ports to which various cables, such as an SPDIF cable, a USB cable, an IEEE 1394 cable, and a TV output cable, can be connected and detects which of the cables is connected to a port. The ports can be implemented differently according to embodiments of the portable device 300, and it is possible for various cables of different types and protocols to be connected to one physical port.

However, a “port” in the present description is not limited to a physical port in shape, but a port by which a cable type or external device type can be identified by detecting a connection state, such as a cable connection state. Therefore, the sensing of a port includes sensing of an interface of an external device connected to the port through various cables or other connection mechanisms. It will be easily understood by those of ordinary skill in the art that an external device can be detected by various methods when the external device is connected to the portable device 300 and are thus not tied to using only specific cable connectors, thus allowing for the use of wireless connections.

For example, when a connected interface uses the IEEE 1394 protocol, if a node is added to or removed from a network, hot-plugging allows the portable device 300 to automatically detect this connection and reconfigure the network. Thus, the port sensing unit 340 can determine an external device connected to the portable device 300 through the IEEE 1394 interface.

If an external device is connected to the USB port of the portable device 300 having a USB OTG function, the portable device 300 can detect the connected external device if a device driver supporting the external device is included in a target peripheral list stored in the portable device 300.

Even though they are not shown, the portable device 300 can include an RF module for communicating with a base station, an audio codec for outputting a stereo audio signal, a microphone, a speaker, and an earphone jack.

FIG. 4 is a diagram of a software layer configuration for generating a content list menu which can be realized in the portable device 300 according to an embodiment of the present invention. Referring to FIG. 4, software layers that can be realized in the present invention are a hardware layer, a device driver layer, a middleware layer, a graphical user interface (GUI) engine layer, and an application layer. The hardware layer is a supportable hardware layer to which a cable is physically connected. The device driver layer is a layer for generating an automatic menu configuration event by sensing a port connected to the hardware layer. The middleware layer is a layer for determining a cable type according to the sensed port and transmitting a content list to the application layer.

The GUI engine layer includes libraries for generating a graphic and/or text type content list menu so that a user can easily perceive the content list. The GUI engine corresponds to the menu generator 350 and provides the generated content list menu to display the menu to the display unit 320. For example, since content which can be output through a display such as a TV includes AV files stored in the portable device 300, a list of files having an “.avi” extension and a “.jpg” extension among the AV files can be provided in a tree pattern. File names can be titles or producers related to the content, and files of other decompressed video formats can be listed. In contrast, those files not reproducible through a TV or other display are not included in the list, but are included in the list when an external device is connected and through which those files can be output.

The application layer receives content list information and constructs a menu using the GUI engine. While not required in all aspects, the middleware layer can be included in the application layer. While the software layers for generating a content list menu are illustrated in FIG. 4, such a configuration can be implemented using hardware and other layer configurations are possible.

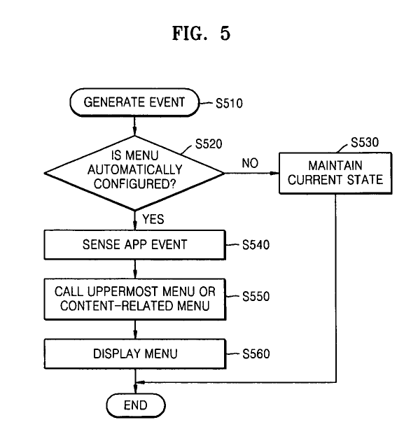

FIG. 5 is a flowchart illustrating an automatic menu construction algorithm according to an embodiment of the present invention. Referring to FIG. 5, when a cable of an external device is connected to the port sensing unit 340 of the portable device 300, an automatic menu configuration event is generated by detecting that the external device is connected (operation S510). The portable device 300 inquires whether a menu is automatically configured through a user interface (operation S520). If a user does not consent that the menu is automatically configured, the portable device 300 maintains its current state (operation S530). However, it is understood that user consent is not required in all aspects such that operations S520 and S530 need not be performed.

If the user consents that the menu is automatically configured, the application layer senses the automatic menu configuration event (operation S540). In operation S550, the application layer calls a menu of the uppermost layer, which represents a list of content according to content type, and/or when a content type is pre-defined, the application layer calls a pre-defined menu. The content list is displayed through the display unit 320 using the menu generator 350 (operation S560).

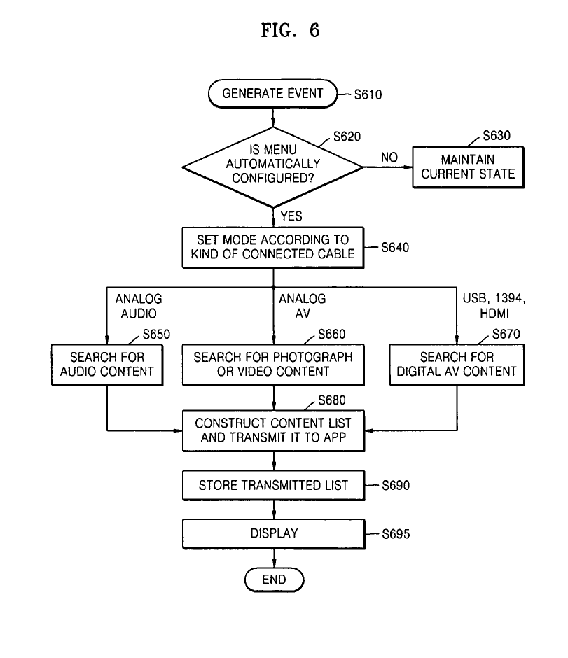

FIG. 6 is a detailed flowchart illustrating the automatic menu construction algorithm of operation S540 in FIG. 5. Referring to FIG. 6, when an automatic menu configuration event is generated by detecting that the external device is connected in operation S610, the portable device 300 enquires whether a menu is automatically configured through a user interface in operation S620. If a user does not consent that the menu is automatically configured, the portable device 300 maintains its current state in operation S630. However, it is understood that the user consent is not required in all aspects of the invention.

If the user consent that the menu is automatically configured, a mode according to the kind of connected cable is set by identifying the kind of connected cable in operation S640. However, it is understood that mode can further be implemented for any wired or wireless connection where the protocol or other external device identification information is identifiable with a corresponding external device based upon the connection, and the portable device 300 generates the corresponding content list according to the identified protocol or external device identification information.

If an SPDIF cable or an analog audio cable is connected to a port of the portable device 300, the portable device 300 searches for audio content stored in the storage unit 330 which corresponds to the analog audio cable (operation S650). The portable device 300 constructs a content list menu based upon the searched audio content determined to correspond to the analog audio cable, and transmits the content list menu of the searched audio content to the application layer in operation S680.

If an analog AV cable is connected to a TV output port of the portable device 300, the portable device 300 searches for audio, photographic, and video content stored in the storage unit 330 which corresponds to the analog AV cable (operation S660). The portable device 300 constructs a content list menu based upon the searched content determined to correspond to the analog AV cable, and transmits the content list menu of the searched content to the application layer in operation S680.

If a USB cable, an IEEE1394 cable, or an HDMI cable is connected to a USB port, an IEEE1394 port, or an HDMI port of the portable device 300 respectively, the portable device 300 searches in the storage unit 330 for digital AV file content, which can be transmitted through the cable and is reproducible in the connected external device (in operation S670). The portable device 300 constructs a content list menu based upon the searched content determined to correspond to the connected cable, and transmits the content list menu to the application layer in operation S680.

It is understood that additional associations can be made, such as associating an IEEE 1394 cable with audio played in a stereo, USB with audio or video played on a computer, and HDMI with video or still pictures played on an HD display.

While not required in all aspects, the content list transmitted to the application layer can be displayed by forming a content list menu using the menu generator 350 in operation S695, and before this, the content list transmitted to the application layer can be stored in the storage unit 330 in operation S690. The user can command the portable device 300 to reproduce a file from the menu provided to the user using an AV file reproduction algorithm implemented in a video processor (not shown) of the portable device 300.

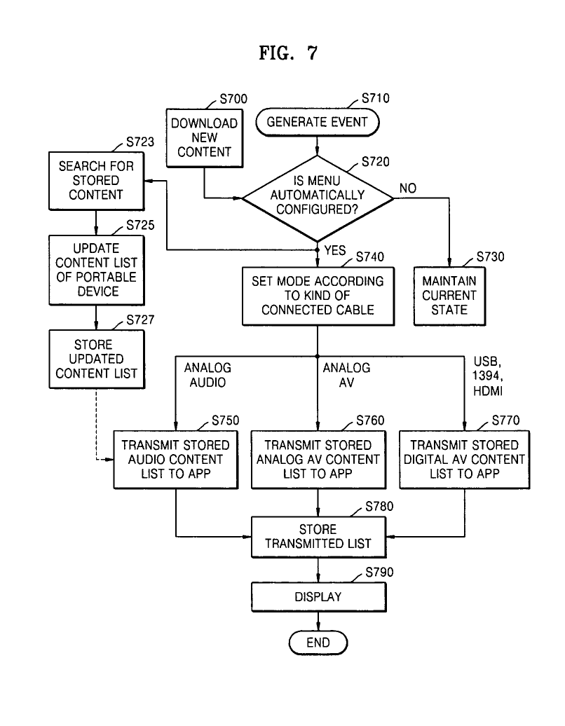

FIG. 7 is a flowchart illustrating an automatic menu construction algorithm according to another embodiment of the present invention. The algorithm of FIG. 7 is the same as the algorithm of FIG. 6 except that a content list is provided to a user by updating the content list when new content is stored, and searching for the updated content list when an automatic menu configuration event is generated.

When a new content is downloaded from a content source, such as a personal computer, in operation S700, the portable device 300 asks the user for whether a menu is automatically configured (operation S720). However, it is understood that user consent is not required in all aspects. If the user consents that the menu is automatically configured, the portable device 300 searches for stored content in operation S723 and updates a content list of the portable device 300 in operation S725. The updated content list is stored in operation S727. By way of example, if the content lists are stored in a tree pattern according to content type, the branch having the corresponding content type is updated and the remaining branches are not updated. In the meantime, the portable devices 300 set mode according to kind of connected cable S740, a content list stored according to the kind of content is transmitted to the application layer in operation S750, S760, or S770. The updated content list information can be classified and stored in a lower directory of a directory for each port.

In more detail, if an SPDIF cable or an analog audio cable is connected to a port, a list of pre-stored audio content is transmitted to the application layer in operation S750. If an analog AV cable is connected to a port, a list of pre-stored analog AV content is transmitted to the application layer in operation S760. If a USB cable, an IEEE1394 cable, or an HDMI cable is connected to a port, a list of pre-stored digital AV content is transmitted to the application layer in operation S770.

When an automatic menu configuration event is generated in a state where new content is not downloaded in operation S710, if a content list is pre-stored in the portable device 300, the pre-stored content list can be provided to the user by transmitting it to the application layer in operation S750, S760, or S770.

As described above, according to embodiments of the present invention, an optimal user interface can be provided to a user by identifying a port connected to a portable device. In addition, an apparatus and method for automatically constructing a list of content stored in a portable device, which can be reproduced in an external device connected to the portable device, and providing the content list to a user can be provided. While described in the context of portable devices, it is understood that aspects of the invention can be used in non-portable devices, and/or that the portable devices need not be used for reproducing in all aspects of the invention.

While aspects of the present invention have been particularly shown and described with reference to exemplary embodiments thereof, it will be understood by those of ordinary skill in the art that various changes in form and detail may be made therein without departing from the spirit and scope of the present invention as defined by the following claims and equivalents thereof.

What is claimed is:

1. An audio/video (AV) file reproducing and/or recording apparatus comprising:
a port sensing unit sensing a connected port by detecting a connection state between a portable device and an external device and to detect a type of the connected port;
a controller providing a list of content reproducible by the external device to the portable device based on the detected type of the connected port;
a menu generator generating a content list menu using the provided content list; and
a display unit displaying the generated content list menu.

2. The apparatus of claim 1, wherein content lists are pre-generated according to content type, the controller selects one of the pre-generated lists and transmits the selected list with the provided content list to the menu generator.

3. The apparatus of claim 1, wherein, when the detected type of connected port is an analog/digital audio port, the controller:
searches for audio content reproducible in an external device connected through the analog/digital audio port among content stored in the portable device, and
provides the search result in the content list.

4. The apparatus of claim 1, wherein when the detected type of connected port is an analog AV port, the controller:
searches for audio, photographic, and/or video content reproducible in an external device connected through the analog AV port among content stored in the portable device, and
provides the search result in the content list.

5. The apparatus of claim 1, wherein when the type of connected port is a USB port, an IEEE 1394 port, and/or a High-Definition Multimedia Interface (HDMI) port, the controller:
searches for digital AV content among content stored in the portable device according to protocols corresponding to the USB port, the IEEE 1394 port, and/or the High-Definition Multimedia Interface (HDMI) port, and
provides the search result in the content list.

6. The apparatus of claim 1, wherein the AV file reproducing apparatus further comprises a storage unit storing the content list generated by the controller.

7. The apparatus of claim 6, wherein:
the content list is obtained by configuring a list of content reproducible in the external device in a tree pattern according to a type of the content, and
a content list according to the type of the content is allocated and stored for each type of port.

8. An audio/video (AV) content reproducing method comprising:
sensing a kind of connected port by detecting a connection state between a portable device and an external device;
providing a list of content reproducible in the external device to the portable device based on the kind of sensed port;
generating a content list menu using the provided content list; and
displaying the generated content list menu.

9. The method of claim 8, wherein the providing the content list comprises, selecting between pre-generated content lists listed according to content type.

10. The method of claim 8, wherein the providing the content list comprises, when the sensed port is an analog/digital audio port,
searching for audio content reproducible in an external device connected through the analog/digital audio port among content stored in the portable device, and
providing the search result in the content list.

11. The method of claim 8, wherein the providing the content list comprises, when the sensed port is an analog AV port,
searching for audio, photographic, and video content reproducible in an external device connected through the analog AV port among content stored in the portable device, and
providing the search result in the content list.

12. The method of claim 8, wherein the providing the content list comprises, when the sensed port is a USB port, an IEEE 1394 port, and/or a High-Definition Multimedia Interface (HDMI) port,
searching for digital AV content among content stored in the portable device according to protocols corresponding to the USB port, the IEEE 1394 port, and/or the High-Definition Multimedia Interface (HDMI) port, and
providing the search result in the content list.

13. The method of claim 8, further comprising storing the generated content list.

14. The method of claim 13, wherein:
the content list is obtained by configuring a list of content reproducible in the external device in a tree pattern according to a type of the content, and
a content list according to the type of the content is allocated for each port and stored.

15. A portable device which reproduces and/or records audio/video (AV) content, comprising:
a port sensing unit sensing a connected port by detecting a connection state between a portable device and an external device;
a controller providing a list of content reproducible in the external device to the portable device based on the kind of sensed port;
a menu generator generating a content list menu, which a user can perceive, using the provided content list; and
a display unit displaying the generated content list menu.

16. The portable device of claim 15, wherein pre-generated content lists are pre-generated according to content type, the controller selectively transmits the pre-generated content lists to the menu generator according to the kind of sensed port.

17. The portable device of claim 15, wherein when the sensed port is an analog/digital audio port, the controller provides a content list by
searching for audio content reproducible in an external device connected through the analog/digital audio port among content stored in the portable device, and
including the search result in the providing content list.

18. The portable device of claim 15, wherein when the sensed port is an analog AV port, the controller provides a content list by
searching for audio, photograph, and/or video content reproducible in an external device connected through the analog AV port among content stored in the portable device, and
including the search result in the providing content list.

19. The portable device of claim 15, wherein when the sensed port is a USB port, an IEEE 1394 port, and/or a High-Definition Multimedia Interface (HDMI) port, the controller provides a content list by
searching for digital AV content among content stored in the portable device according to protocols corresponding to the USB port, the IEEE 1394 port, and/or the High-Definition Multimedia Interface (HDMI) port, and
including the search result in the providing content list.

20. The portable device of claim 15, wherein the AV file reproducing apparatus further comprises a storage unit storing the content list generated by the controller.

21. The portable device of claim 20, wherein:
the content list is obtained by configuring a list of content reproducible in the external device in a tree pattern according to the type of the content, and
a content list according to the type of the content is allocated and stored for each port.

22. A portable file reproducing and/or recording apparatus comprising:
an external connection sensing unit which generates a detection signal indicating which one of first and second types of external device are connected to the apparatus and is capable of detecting a connection with each of the first and second types of external devices;
a storage unit which stores a first type of content reproducible by the first type of external, and a second type of content reproducible by the second type of external device; and
a controller which associates the first and second types of external devices with the stored content, and outputs a menu according to generated the detection signal, the menu including the first type of content when the detection signal indicates that the first type of external device is connected, and the second type of content when the detection signal indicates that the second type of external device is connected.

23. The portable file reproducing and/or recording apparatus of claim 22, wherein the external connection sensing unit detects the first type of external device when the connection is made according to a first protocol, and detects the second type of external device when the connection is made according to a second protocol.

24. The portable file reproducing and/or recording apparatus of claim 23, wherein:
the first type of content is audio data,
the first protocol is associated with reproducing audio data in the first type of external device,
the second type of content is non-audio data, and
the second protocol is associated with reproducing the non-audio data in the second type of external device.

25. The portable file reproducing and/or recording apparatus of claim 23, wherein:
the first type of content is a video data,
the first protocol is associated with reproducing video data in the first type of external device,
the second type of content is still picture data, and
the second protocol is associated with reproducing the still picture in the second type of external device.

26. The portable file reproducing and/or recording apparatus of claim 23, wherein:
the first type of content is video data,
the first protocol is associated with reproducing video data in the first type of external device,
the second type of content is non-video data, and
the second protocol is associated with reproducing the non-video data in the second type of external device.

27. The portable file reproducing and/or recording apparatus of claim 24, wherein one of the first and second protocols corresponds to a cable connection made through a USB port, an IEEE 1394 port, or a High-Definition Multimedia Interface (HDMI) port.

28. The portable file reproducing and/or recording apparatus of claim 22, wherein the first type of external device is a display compatible with the first type of data, and the second type of external device is an audio recording and/or reproducing device compatible with the second type of data.

29. The portable file reproducing and/or recording apparatus of claim 22, wherein the controller associates the first and second types of external devices according to file extensions of the stored contents.

30. The portable file reproducing and/or recording apparatus of claim 22, wherein the controller outputs the menu without receiving input from a user as to the connected type of external device.

31. The portable file reproducing and/or recording apparatus of claim 30, further comprising a display, wherein the controller outputs the menu to the display.

32. The portable file reproducing and/or recording apparatus of claim 22, wherein the controller determines when additional content is stored in the storage unit, and associates the additional content with the first and second types of external devices according to a detected type of the additional content.

33. The portable file reproducing and/or recording apparatus of claim 22, wherein the controller associates the first and second types of external devices with the stored content prior to receiving the detection signal.

34. The portable file reproducing and/or recording apparatus of claim 22, wherein the controller associates the first and second types of external devices with the stored content prior to receiving the detection signal after receiving the detection signal.

35. A computer readable medium encoded with processing instructions usable by a computer to implement the method of claim 8.
